(19) United States
(12) Patent Application Publication
(10) Pub. No.: US 2009/0008964 A1
(43) Pub. Date: Jan. 8, 2009

(54) MODULAR TRUCK BODY

(75) Inventor: Bruce Skipper, Mohnton, PA (US)

Correspondence Address: PEPPER HAMILTON LLP, ONE MELLON CENTER, 50TH FLOOR, 500 GRANT STREET, PITTSBURGH, PA, 15219, US

(73) Assignee: READING TRUCK BODY, INC., Shillington, PA (US)

(21) Appl. No.: 11/951,645

(22) Filed: Dec. 6, 2007

Related U.S. Application Data
(60) Provisional application No. 60/947,568, filed on Jul. 2, 2007.

(51) Int. Cl. B62D 33/04

(52) U.S. Cl. 296/193.04

(57) ABSTRACT

A modular truck body. The modular truck body includes a floor assembly, a first storage assembly removably connected to the floor assembly, a second storage assembly removably connected to the floor assembly, and a bulkhead removably connected to the first and second storage assemblies.

### CROSS-REFERENCE TO RELATED APPLICATIONS

This application claims the priority benefit of U.S. Provisional Patent Application No. 60/947,568, filed on Jul. 2, 2007.

### BACKGROUND

This application discloses an invention that is related, generally and in various embodiments, to a modular truck body.

There are many types of truck bodies which can be mounted to the chassis of a truck. For example, a common type of truck body utilized in the building trades is a pre-assembled truck body which has a floor, a bulkhead positioned near the cab of the truck, storage compartments positioned along the left and right sides of the truck, and a tailgate positioned at the rear of the truck. For such pre-assembled truck bodies, the floor, the bulkhead, and the storage compartments are generally welded to one another.

For a variety of reasons, one or more of the components of the pre-assembled truck body often incurs significant damage. For example, it is not uncommon for one of the storage compartments to become damaged beyond the point of usefulness. Because various components of the pre-assembled truck body are welded to one another, it is not practical to attempt to replace only the damaged component. Rather, the entire pre-assembled truck body is often replaced by another pre-assembled truck body, even when only one of the components is damaged. The need to replace the entire pre-assembled truck body is both time-consuming and expensive.

### SUMMARY

In one general respect, this application discloses a modular truck body. According to various embodiments, the modular truck body includes a floor assembly, a first storage assembly removably connected to the floor assembly, a second storage assembly removably connected to the floor assembly, and a bulkhead removably connected to the first and second storage assemblies.

### DESCRIPTION OF DRAWINGS

Various embodiments of the invention are described herein by way of example in conjunction with the following figures.

FIG. 1 illustrates various embodiments of a modular truck body;

FIG. 2 illustrates a bottom view of various embodiments of a floor assembly of the modular truck body of FIG. 1;

FIG. 3 illustrates a side view of various embodiments of a floor assembly of the modular truck body of FIG. 1;

FIG. 4 illustrates various embodiments of a first cross member assembly of the floor assembly of FIG. 2;

FIG. 5 illustrates various embodiments of a storage assembly of the modular truck body of FIG. 1;

FIG. 6 illustrates various embodiments of a first end of the storage assembly of FIG. 5;

FIG. 7 illustrates various embodiments of a second end of the storage assembly of FIG. 5;

FIG. 8 is a side view of various embodiments of the storage assembly of FIG. 5;

FIG. 9 illustrates various embodiments of another storage assembly of the modular truck body of FIG. 1;

FIG. 10 illustrates various embodiments of a first end of the storage assembly of FIG. 9;

FIG. 11 illustrates various embodiments of a second end of the storage assembly of FIG. 9;

FIG. 12 is a side view of various embodiments of the storage assembly of FIG. 9;

FIG. 13 illustrates various embodiments of a bulkhead of the modular truck body of FIG. 1; and

FIG. 14 illustrates various embodiments of a tailgate assembly of the modular truck body of FIG. 1.

### DETAILED DESCRIPTION

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

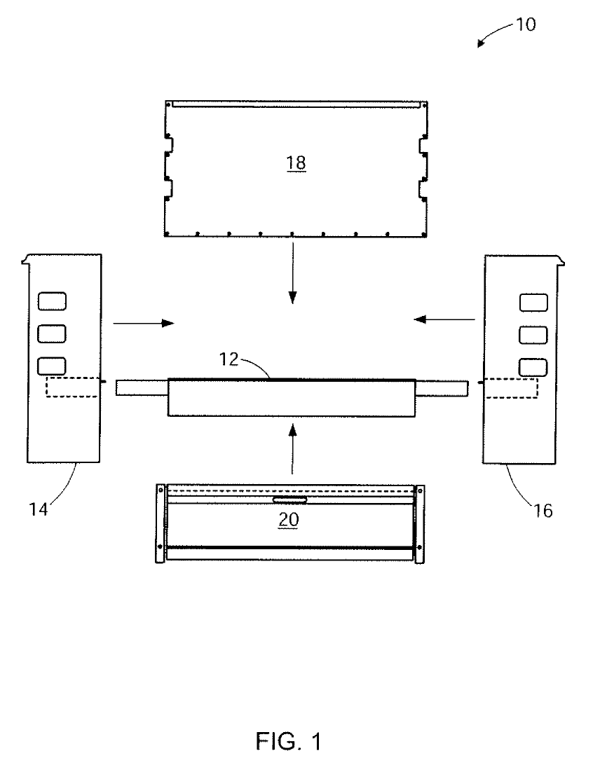

FIG. 1 illustrates various embodiments of a modular truck body 10. For reasons of clarity, an exploded view of the modular truck body 10 is shown in FIG. 1. The modular truck body 10 is configured for mounting to a truck body, and includes a floor assembly 12, a first storage assembly 14, a second storage assembly 16 opposite the first storage assembly 14, and a bulkhead 18. The modular truck body 10 may also include a tailgate assembly 20.

As will be explained in more detail hereinbelow, the floor assembly 12 is removably connected to the first and second storage assemblies 14, 16 at a number of locations. For example, the dashed lines of the first and second storage assemblies 14, 16 shown in FIG. 1 indicate respective areas where the floor assembly 12 is removably connected to the first and second storage assemblies 14, 16. Also, as will be explained in more detail hereinbelow, the floor assembly 12 is also removably connected to the first storage assembly 14 at a flange of the first storage assembly 14, to the second storage assembly 16 at a flange of the second storage assembly 16, and to the bulkhead 18. In addition, as will be explained in more detail hereinbelow, each of the first and second storage assemblies 14, 16 are also removably connected to the bulkhead 18, and may also be removably connected to the tailgate assembly 20.

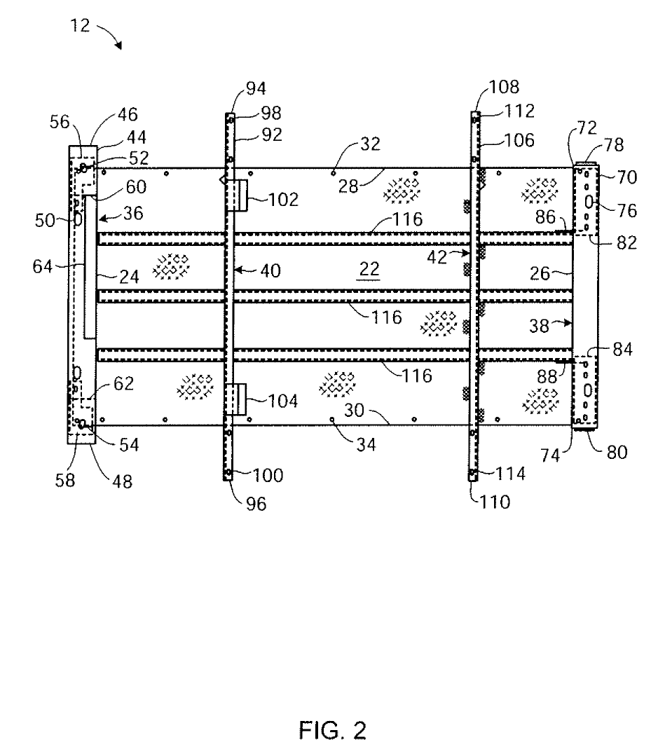

FIG. 2 illustrates a bottom view of various embodiments of the floor assembly 12. The floor assembly 12 includes a rectangular-shaped deck member 22. The deck member 22 may be fabricated from any suitable material in any suitable configuration. For example, according to various embodiments, the deck member 22 is fabricated in a plate configuration as shown in FIG. 2. According to other embodiments, the deck member 22 is fabricated in a ribbed configuration. The deck member 22 includes a first end 24, a second end 26, a first side 28, and a second side 30. The first end 24 is opposite the second end 26 and the first side 28 is opposite the second side 30. When the modular truck body 10 is fully assembled, the first end 24 of the deck member 22 is positioned proximate the bulkhead 18, the second end 26 of the deck member 22 is positioned proximate the tailgate assembly 20, the first side 28 is positioned proximate the first storage assembly 14, and the second side 30 is positioned proximate the second storage assembly 16. The deck member 22 defines one or more openings 32 which pass therethrough along the first side 28 thereof and one or more openings 34 which pass therethrough along the second side 30 thereof. According to various embodiments, the first storage assembly 14 is removably connected to the floor assembly 12 via fasteners (e.g., bolts) which pass through the openings 32, and the second storage assembly 16 is removably connected to the floor assembly 12 via fasteners (e.g., bolts) which pass through the openings 34.

The floor assembly 12 also includes a first cross member assembly 36, a second cross member assembly 38, a third cross member assembly 40, and a fourth cross member assembly 42. The first cross member assembly 36 is connected to the deck member 22, is positioned proximate the first end 24 of the deck member 22, and extends past the first and second sides 28, 30 of the deck member 22. The second cross member assembly 38 is connected to the deck member 22 and is positioned proximate the second end 26 of the deck member 22. The third cross member assembly 40 is connected to the deck member 22, is positioned between the first and second cross member assemblies 36, 38, and extends past the first and second sides 28, 30 of the deck member 22. The fourth cross member assembly 42 is connected to the deck member 22, is positioned between the second and third cross member assemblies 38, 40, and extends past the first and second sides 28, 30 of the deck member 22.

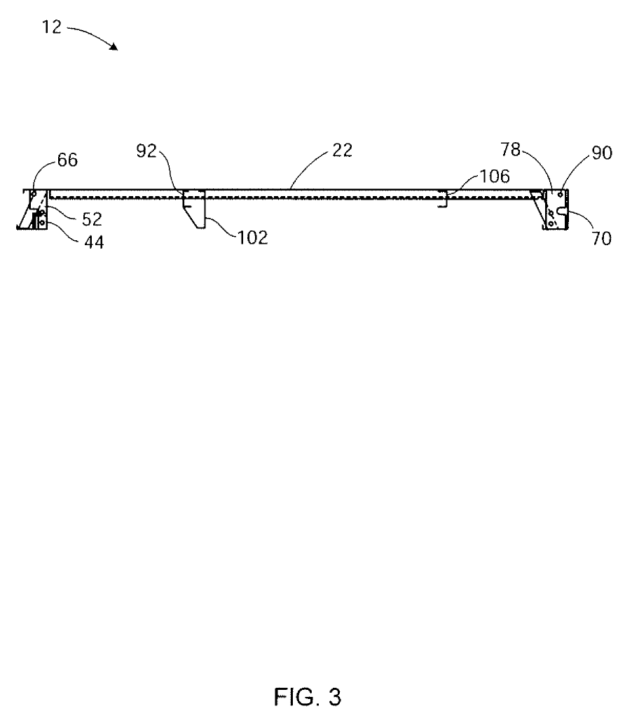

The first cross member assembly 36 includes a channel 44 having a first end 46 and a second end 48 opposite the first end 44. The channel 44 defines one or more openings 50 (e.g., slots) which pass therethrough. According to various embodiments, the floor assembly 12 may be removably connected to the chassis of a truck via fasteners (e.g., bolts) which pass thru the openings 50. The channel 44 may be of any suitable configuration. For example, as shown in FIG. 3, a side view of the floor assembly 12, the channel 44 is a c-shaped channel having a first return lip and a second return lip. According to various embodiments, the first return lip defines one or more openings, and the bulkhead 18 is removably connected to the floor assembly 12 via fasteners (e.g., bolts) which pass through the openings defined by the first return lip.

The first cross member assembly 36 also includes a first mounting member 52 positioned within the channel 44 proximate the first end 46 of the channel 44, and a second mounting member 54 positioned within the channel 44 proximate the second end 48 of the channel 44. The first end 46 of the channel 44 extends past the first side 28 of the deck member 22 and the second end 48 of the channel 44 extends past the second side 30 of the deck member 22.

According to various embodiments, the first cross member assembly 36 also includes a first stiffener member 56 positioned within the channel 44 proximate the first end 46 of the channel 44, a second stiffener member 58 positioned within the channel 44 proximate the second end 48 of the channel 44, a first gusset member 60 positioned within the channel 44 between the first and second mounting members 52, 54, a second gusset member 62 positioned within the channel 44 between the first and second mounting members 52, 54, and a structural steel angle 64 positioned within the channel 44 between the first and second gusset members 60, 62.

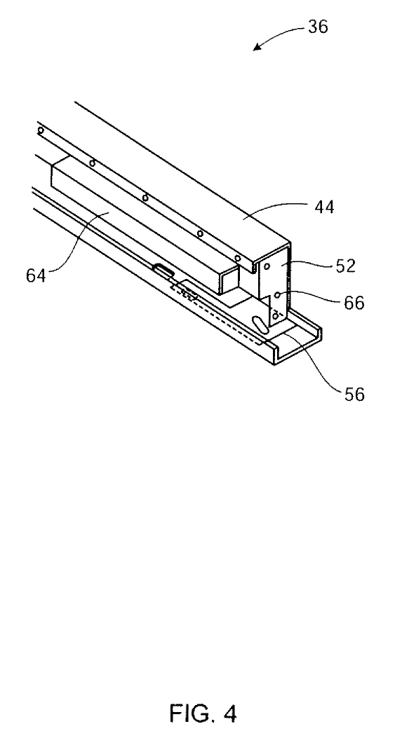

As shown in FIG. 4, a perspective view of a portion of the first cross member assembly 36, the first mounting member 52 defines one or more openings 66 which pass therethrough. According to various embodiments the first storage assembly 14 is removably connected to the floor assembly 12 via fasteners (e.g., bolts) which pass thru the openings 66. The second mounting member 54 is similar to the first mounting member 52. The second mounting member 54 defines one or more openings which pass therethrough. According to various embodiments, the second storage assembly 16 is removably connected to the floor assembly 12 via fasteners (e.g., bolts) which pass through the openings defined by the second mounting member 54.

Returning to FIG. 2, the second cross member assembly 38 includes a channel 70 having a first end 72 and a second end 74 opposite the first end 72. The channel 70 defines one or more openings 76 (e.g., slots) which pass therethrough. According to various embodiments, the floor assembly 12 may be removably connected to the chassis of a truck via fasteners (e.g., bolts) which pass thru the openings 76. The channel 70 may be of any suitable configuration. For example, as shown in FIG. 3, a side view of the floor assembly 12, the channel 70 is a c-shaped channel having a return lip. The second cross member assembly 38 also includes a first mounting member 78 positioned within the channel 70 proximate the first end 72 of the channel 70, and a second mounting member 80 positioned within the channel 70 proximate the second end 74 of the channel 70.

According to various embodiments, the second cross member assembly 38 also includes a first stiffener member 82 positioned within the channel 70 proximate the first end 72 of the channel 70, a second stiffener member 84 positioned within the channel 70 proximate the second end 74 of the channel 70, a first gusset member 86 positioned within the channel 70 between the first and second mounting members 78, 80, and a second gusset member 88 positioned within the channel 70 between the first and second mounting members 78, 80.

As shown in FIG. 3, the first mounting member 78 defines one or more openings 90 which pass therethrough. According to various embodiments, the first storage assembly 14 is removably connected to the floor assembly 12 via fasteners (e.g., bolts) which pass thru the openings 90. The second mounting member 80 is similar to the first mounting member 78. The second mounting member 80 also defines openings which pass therethrough. According to various embodiments, the second storage assembly 16 is removably connected to the floor assembly 12 via fasteners (e.g., bolts) which pass thru the openings defined by the second mounting member 80.

Returning to FIG. 2, the third cross member assembly 40 includes a channel 92 having a first end 94 and a second end 96 opposite the first end 94. The channel 92 defines one or more openings 98 and which pass therethrough and are positioned proximate the first end 94 of the channel 92, and also defines one or more openings 100 which pass therethrough and are proximate the second end 96 of the channel 92. According to various embodiments, the first storage assembly 14 is removably connected to the floor assembly 12 via fasteners (e.g., bolts) which pass thru the openings 98, and the second storage assembly 16 is removably connected to the floor assembly 12 via fasteners (e.g., bolts) which pass through the openings 100. The channel 92 may be of any suitable configuration. For example, as shown in FIG. 3, a side view of the floor assembly 12, the channel 92 is a c-shaped channel.

The first end 94 of the channel 92 extends past the first side 28 of the deck member 22 and the second end 96 of the channel 92 extends past the second side 30 of the deck member 22. According to various embodiments, the third cross member assembly 40 may also include a first reinforcing channel 102 connected to the deck member 22 and the channel 92, and a second reinforcing channel 104 connected to the deck member 22 and the channel 92. As shown in FIG. 3, the first reinforcing channel 102 is a c-shaped channel having an angled return lip.

Returning to FIG. 2, the fourth cross member assembly 42 includes a channel 106 having a first end 108 and a second end 110 opposite the first end 108. The channel 106 may be of any suitable configuration. For example, as shown in FIG. 3, a side view of the floor assembly 12, the channel 106 is a c-shaped channel. The first end 108 of the channel 106 extends past the first side 28 of the deck member 22 and the second end 110 of the channel 106 extends past the second side 30 of the deck member 22. The channel 106 defines one or more openings 112 which pass therethrough and are positioned proximate the first end 108 of the channel 106. The channel 106 also defines one or more openings 114 which pass therethrough and are proximate the second end 110 of the channel 106. According to various embodiments, the first storage assembly 14 is removably connected to the floor assembly 12 via fasteners (e.g., bolts) which pass thru the openings 112, and the second storage assembly 16 is connected to the floor assembly 12 via fasteners (e.g., bolts) which pass through the openings 114. The fourth cross member assembly 42 may also include one or more reinforcing channels connected to the deck member 22 and the channel 106.

As shown in FIG. 2, the floor assembly 12 may also include one or more longitudinal channels 116 connected to the deck member 22 between the first and second cross member assemblies 36, 38. According to various embodiments, at least one of the longitudinal channels 116 is connected to at least one of the first and second gusset members 86, 88 of the second cross member assembly 38. For example, as shown in FIG. 2, the longitudinal channel 116 positioned closest to the first side 28 of the deck member 22 is connected to the first gusset member 86, and the longitudinal member 116 positioned closest to the second side 30 of the deck member 22 is connected to the second gusset 88.

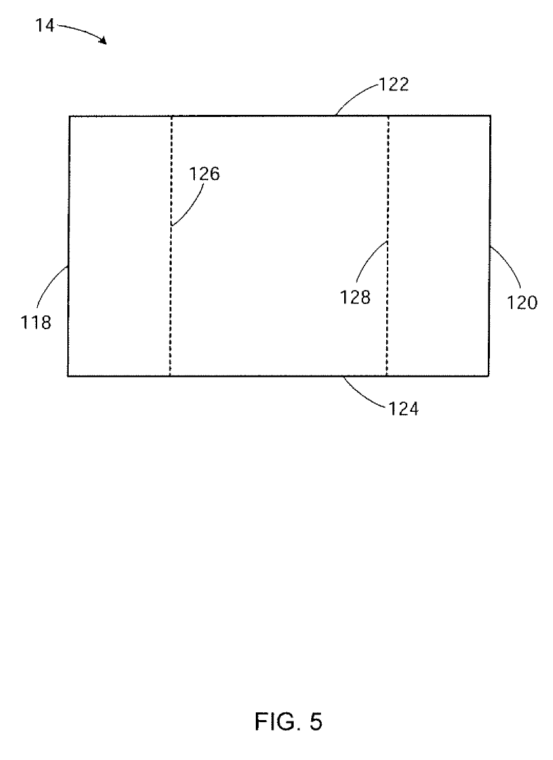

FIG. 5 illustrates a top view of various embodiments of the first storage assembly 14. The first storage assembly 14 includes a first end 118, a second end 120, a first side 122, a second side 124, a first partition wall 126, and a second partition wall 128. The first end 118 is positioned proximate the first end 24 of the deck member 22, and the second end 120 is positioned proximate the second end 26 of the deck member 22. The first side 122 is positioned proximate the first side 28 of the deck member 22, and the second side 124 (e.g., the road side) is positioned opposite the first side 122. The first partition wall 126 is positioned between the first and second ends 118, 120 of the first storage assembly 14, and is connected to the first and second sides 122, 124 of the first storage assembly 14. The second partition wall 128 is positioned between the first partition wall 126 and the second end 120 of the first storage assembly 14, and is connected to the first and second sides 122, 124 of the first storage assembly 14.

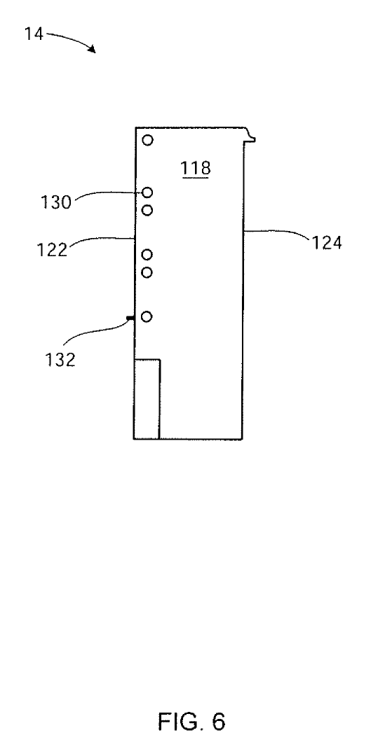

FIG. 6 illustrates various embodiments of the first end 118 of the first storage assembly 14. The first end 118 of the first storage assembly 14 defines one or more openings 130 which pass therethrough. According to various embodiments, the bulkhead 18 is removably connected to the first storage assembly 14 via fasteners (e.g., bolts) which pass through the openings 130. As shown in FIG. 6, the first side 122 of the first storage assembly 14 includes a flange 132 which extends therefrom. According to various embodiments, the flange 132 is formed integrally with the first side 122 of the first storage assembly 14. According to other embodiments, the flange 132 is connected to the first side 122 of the first storage assembly 14. The flange 132 defines one or more openings which pass therethrough. According to various embodiments, the first storage assembly 14 is removably connected to the floor assembly 12 via fasteners (e.g., bolts) which pass through the openings defined by the flange 132 and through the openings 32 defined by the deck member 22.

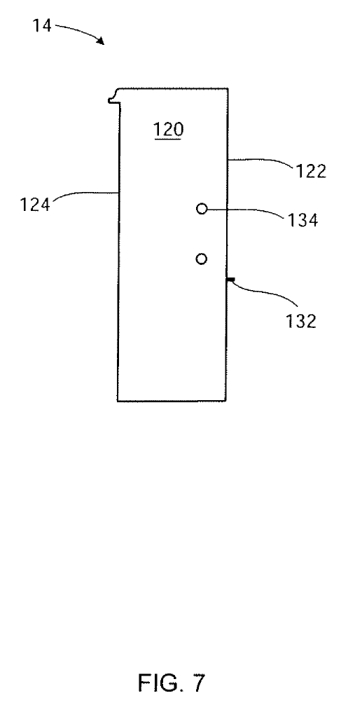

FIG. 7 illustrates various embodiments of the second end 120 of the first storage assembly 14. The second end 120 of the first storage assembly 14 defines one or more openings 134 which pass therethrough. According to various embodiments, the tailgate assembly 20 is removably connected to the first storage assembly 14 via fasteners (e.g., bolts) which pass through the openings 134.

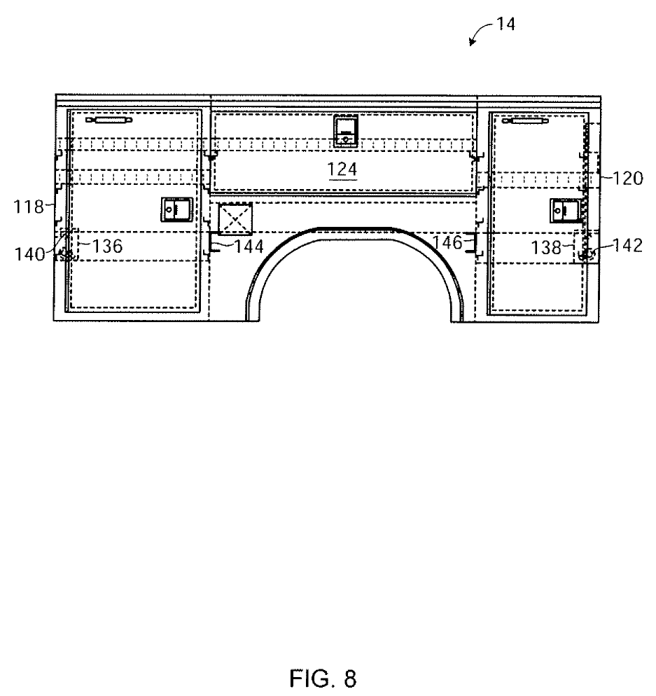

FIG. 8 is a side view of various embodiments of the first storage assembly 14. The second side 124 of the first storage assembly 14 has one or more doors hingedly connected thereto, and includes a curved portion. The first side 122 of the first storage assembly 14 defines one or more openings proximate the first end 118 of the first storage assembly 14, and also defines one or more openings proximate the second end 120 of the first storage assembly 14. According to various embodiments, the first storage assembly 14 is removably connected to the floor assembly 12 via fasteners (e.g., bolts) which pass through the openings defined by the first side 122 of the first storage assembly 14 proximate the first end 118 of the first storage assembly 12 and through the openings 66 defined by the first mounting member 52 of the first cross member assembly 36. According to various embodiments, the first storage assembly 14 is also removably connected to the floor assembly 14 via fasteners (e.g., bolts) which pass through the openings defined by the first side 122 of the first storage assembly 14 proximate the second end 120 of the first storage assembly 14 and through the openings 90 defined by the first mounting member 78 of the second cross member assembly 38.

As shown in FIG. 8, the first storage assembly 14 may also includes a first mounting member 136 (shown by dashed lines) connected to the first side 122 of the first storage assembly 14 proximate the first end 118 of the first storage assembly 14, and a second mounting member 138 (shown by dashed lines) connected to the first side 122 of the first storage assembly 14 proximate the second end 120 of the first storage assembly 14. The first mounting member 136 defines one or more openings 140 which pass therethrough, and the second mounting member 138 defines one or more openings 142 which pass therethrough.

According to various embodiments, the first storage assembly 14 is removably connected to the floor assembly 12 via fasteners (e.g., bolts) which pass through the openings 140 defined by the first mounting member 136, through the openings defined by the first side 122 of the first storage assembly 14 proximate the first end 118, and through the openings 66 of the first mounting member 52 of the first cross member assembly 36. According to various embodiments, the first storage assembly 14 is also removably connected to the floor assembly 12 via fasteners (e.g., bolts) which pass through the openings 142 defined by the second mounting member 138, through the openings defined by first side 122 of the first storage assembly 14 proximate the second end 120, and through the openings 90 defined by the first mounting member 78 of the second cross member assembly 38.

The first storage assembly 14 also includes a first channel 144 connected to the first partition wall 126, and a second channel 146 connected to the second partition wall 128. The first channel 144 is configured to receive the first end 94 of the channel 92 of the third cross member assembly 40 of the floor assembly 12. The first channel 144 defines one or more openings which pass therethrough. According to various embodiments, the first storage assembly 14 is removably connected to the floor assembly 12 via fasteners (e.g., bolts) which pass through the openings defined by the first channel 144 and through the openings 98 defined by the channel 92 of the third cross member assembly 40. The second channel 146 is configured to receive the first end 108 of the channel 106 of the fourth cross member assembly 42 of the floor assembly 12. The second channel 146 defines one or more openings which pass therethrough. According to various embodiments, the first storage assembly 14 is also removably connected to the floor assembly 12 via fasteners (e.g., bolts) which pass through the openings defined by the second channel 146 and through the openings 112 defined by the channel 106 of the fourth cross member assembly 40. The positioning of the first and second channels 144, 146 with respect to the channels 92, 106 of the floor assembly 12 provides for accurate alignment of the first storage assembly 14 with the floor assembly 12.

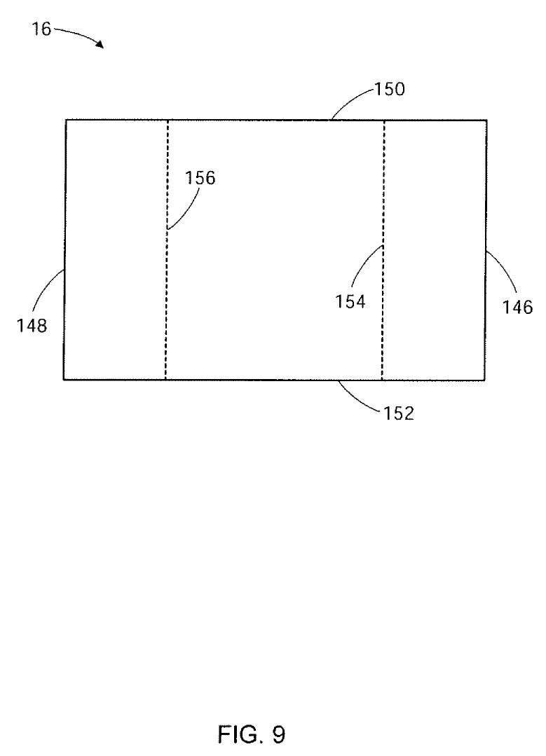

FIG. 9 illustrates a top view of various embodiments of the second storage assembly 16. The second storage assembly 16 includes a first end 146, a second end 148, a first side 150, a second side 152, a first partition wall 154, and a second partition wall 156. The first end 146 is positioned proximate the first end 24 of the deck member 22, and the second end 148 is positioned proximate the second end 26 of the deck member 22. The first side 150 is positioned proximate the second side 30 of the deck member 22, and the second side 152 (e.g., the curb side) is positioned opposite the first side 150. The first partition wall 154 is positioned between the first and second ends 146, 148 of the second storage assembly 16, and is connected to the first and second sides 150, 152 of the second storage assembly 16. The second partition wall 156 is positioned between the first partition wall 154 and the second end 148 of the second storage assembly 16, and is connected to the first and second sides 150, 152 of the second storage assembly 16.

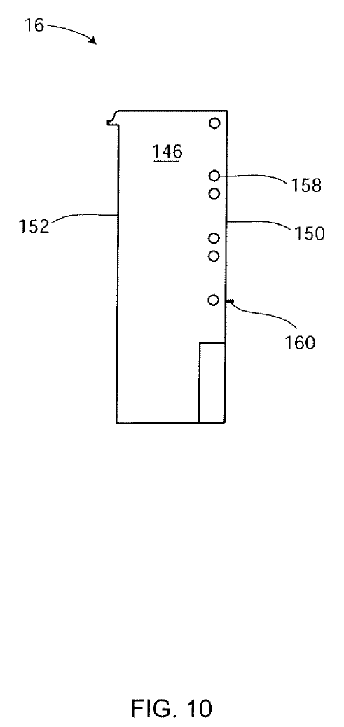

FIG. 10 illustrates various embodiments of the first end 146 of the second storage assembly 16. The first end 146 of the second storage assembly 16 defines one or more openings 158 which pass therethrough. According to various embodiments, the bulkhead 18 is removably connected to the second storage assembly 16 via fasteners (e.g., bolts) which pass through the openings 158. As shown in FIG. 10, the first side 150 of the second storage assembly 16 includes a flange 160 which extends therefrom. According to various embodiments, the flange 160 is formed integrally with the first side 150 of the second storage assembly 16. According to other embodiments, the flange 160 is connected to the first side 150 of the second storage assembly 16. The flange 160 defines one or more openings which pass therethrough. According to various embodiments, the second storage assembly 16 is removably connected to the floor assembly 12 via fasteners (e.g., bolts) which pass through the openings defined by the flange 160 and the openings 34 defined by the deck member 22.

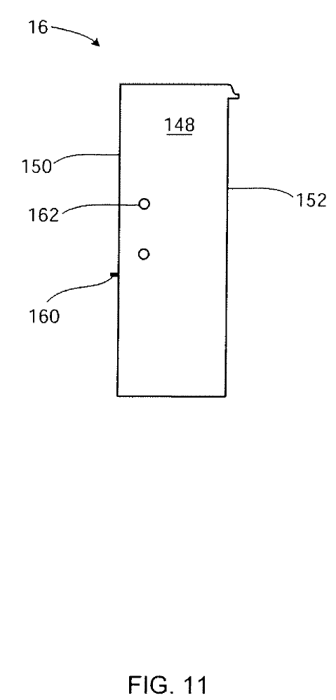

FIG. 11 illustrates various embodiments of the second end 148 of the second storage assembly 16. The second end 148 of the second storage assembly 16 defines one or more openings 162 which pass therethrough. According to various embodiments, the second storage assembly 16 is removably connected to the tailgate assembly 20 via fasteners (e.g., bolts) which pass through the openings 162.

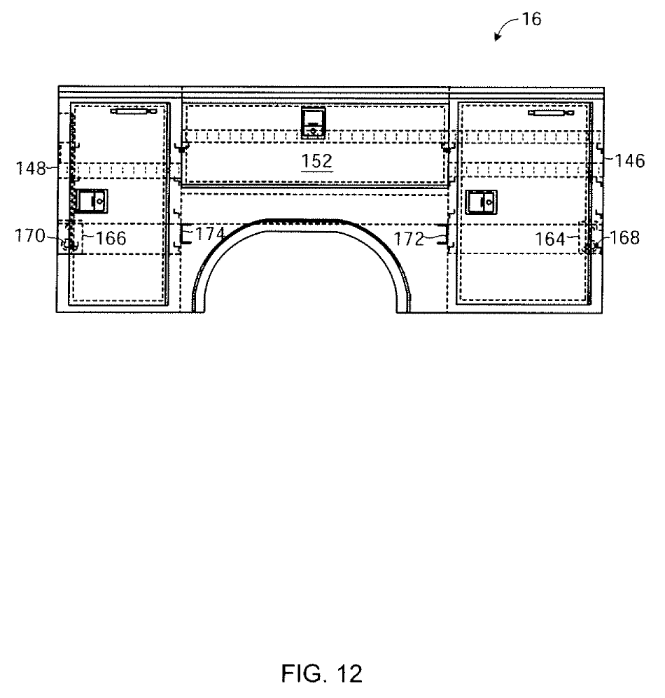

FIG. 12 is a side view of various embodiments of the second storage assembly 16. The second side 152 of the second storage assembly 16 has one or more doors hingedly connected thereto, and includes a curved portion. The first side 150 of the second storage assembly 16 defines one or more openings proximate the first end 146 of the second storage assembly 16, and also defines one or more openings proximate the second end 148 of the second storage assembly 16. According to various embodiments, the second storage assembly 16 is removably connected to the floor assembly 12 via fasteners (e.g., bolts) which pass through the openings defined by the first side 150 of the second storage assembly 16 proximate the first end 146 of the second storage assembly 16 and through the openings 68 defined by the second mounting member 54 of the first cross member assembly 36. According to various embodiments, the second storage assembly 16 is also removably connected to the floor assembly 12 via fasteners (e.g., bolts) which pass through the openings defined by the first side 150 of the second storage assembly 16 proximate the second end 148 of the second storage assembly 16 and through the openings defined by the second mounting member 80 of the second cross member assembly 38.

As shown in FIG. 12, the second storage assembly 16 may also includes a first mounting member 164 (shown by dashed lines) connected to the first side 150 of the second storage assembly 16 proximate the first end 146 of the second storage assembly 16, and a second mounting member 166 (shown by dashed lines) connected to the first side 150 of the second storage assembly 16 proximate the second end 148 of the second storage assembly 16. The first mounting member 164 defines one or more openings 168 which pass therethrough, and the second mounting member 166 defines one or more openings 170 which pass therethrough.

According to various embodiments, the second storage assembly 16 is removably connected to the floor assembly 12 via fasteners (e.g., bolts) which pass through the openings 168 defined by the first mounting member 164, through the openings defined by the first side 150 of the second storage assembly 16 proximate the first end 146, and through the openings 68 of the second mounting member 54 of the first cross member assembly 36. According to various embodiments, the second storage assembly 16 is also removably connected to the floor assembly 12 via fasteners (e.g., bolts) which pass through the openings 170 defined by the second mounting member 166, through the openings defined by first side 150 of the second storage assembly 16 proximate the second end 148, and through the openings defined by the second mounting member 80 of the second cross member assembly 38.

The second storage assembly 16 also includes a first channel 172 connected to the first partition wall 154, and a second channel 174 connected to the second partition wall 156. The first channel 172 is aligned with the first channel 144 of the first storage assembly 14, and is configured to receive the second end 96 of the channel 92 of the third cross member assembly 40 of the floor assembly 12. The first channel 172 defines one or more openings which pass therethrough. According to various embodiments, the second storage assembly 16 is removably connected to the floor assembly 12 via fasteners (e.g., bolts) which pass through the openings defined by the first channel 172 and through the openings 100 defined by the channel 92 of the third cross member assembly 40.

The second channel 174 is aligned with the second channel 146 of the second storage assembly 16, and is configured to receive the second end 110 of the channel 106 of the fourth cross member assembly 42 of the floor assembly 12. The second channel 174 defines one or more openings which pass therethrough. According to various embodiments, the second storage assembly 16 is removably connected to the floor assembly 12 via fasteners (e.g., bolts) which pass through the openings defined by the second channel 174 and through the openings 114 defined by the channel 106 of the fourth cross member assembly 40. The positioning of the first and second channels 172, 174 with respect to the channels 92, 106 of the floor assembly 12 provides for accurate alignment of the second storage assembly 16 with the floor assembly 12.

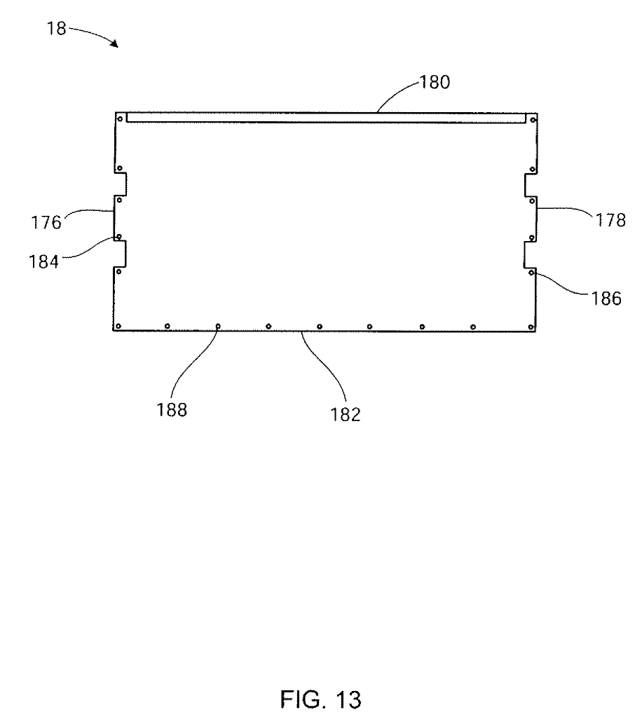

FIG. 13 illustrates various embodiments of the bulkhead 18. The bulkhead 18 may be fabricated from any suitable material in any suitable configuration. For example, according to various embodiments, the bulkhead 18 is fabricated in a plate configuration as shown in FIG. 13. According to other embodiments, the bulkhead 18 is fabricated in a ribbed configuration. The bulkhead 18 includes a first end 176, a second end 178, a first side 180, and a second side 182. The bulkhead 18 defines one or more openings 184 which pass therethrough proximate the first end 176, one or more openings 186 which pass therethrough proximate the second end 178, and one or more openings 188 which pass therethrough proximate the second side 182.

According to various embodiments, the first storage assembly 14 is removably connected to the bulkhead 18 via fasteners (e.g., bolts) which pass through the openings 184 and through the openings defined by the first end 118 of the first storage assembly 14. According to various embodiments, the second storage assembly 16 is removably connected to the bulkhead 18 via fasteners (e.g., bolts) which pass through the openings 186 and through the openings defined by the first end 146 of the second storage assembly 16. According to various embodiments, the bulkhead 18 is removably connected to the floor assembly 12 via fasteners (e.g., bolts) which pass through the openings 188 and through openings defined by one of the lips of the channel 44 of the first cross member assembly 36.

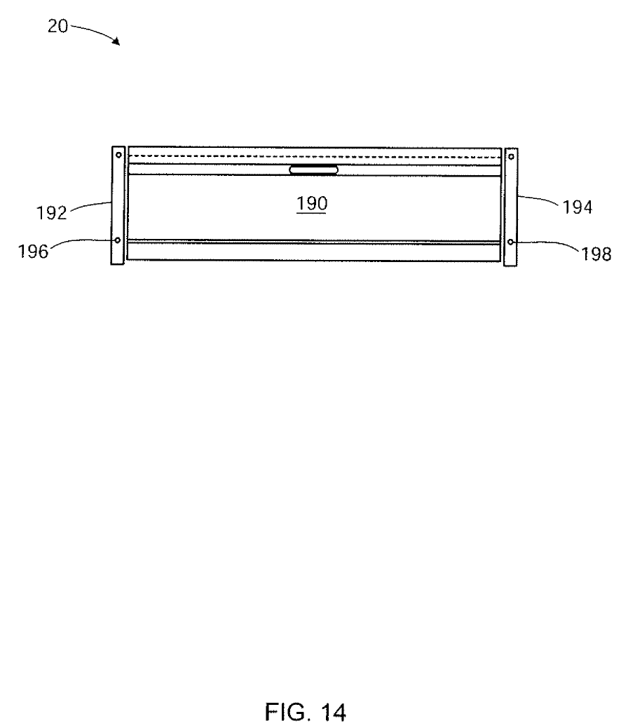

FIG. 14 illustrates various embodiments of the tailgate assembly 20. The tailgate assembly 20 includes a tailgate 190, a first mounting bracket 192, and a second mounting bracket 194. The tailgate 190 may be connected to the first and second mounting brackets 192, 194 in any suitable manner. For example, according to various embodiments, the tailgate 190 is connected to the first and second mounting brackets 192, 194 via hinges. The first mounting bracket 192 defines one or more openings 196, and the second mounting bracket 194 defines one or more openings 196.

According to various embodiments, the tailgate assembly 20 is removably connected to the first storage assembly 14 via fasteners (e.g., bolts) which pass through the openings 196 and through the openings 134 defined by the second end 120 of the first storage assembly 14. According to various embodiments, the tailgate assembly 20 is removably connected to the second storage assembly 16 via fasteners (e.g., bolts) which pass through the openings 198 and through the openings 162 defined by the second end 148 of the second storage assembly 16.

Based on the above-described removable connections between the first storage assembly 14 and the floor assembly 12, and the removable connections between the second storage assembly 16 and the floor assembly 12, one can appreciate how easily a damaged first storage assembly 14 and/or a damaged second storage assembly 16 can be disconnected from the floor assembly 12 and replaced.

While several embodiments of the invention have been described herein by way of example, those skilled in the art will appreciate that various modifications, alterations, and adaptions to the described embodiments may be realized without departing from the spirit and scope of the invention defined by the appended claims.

What is claimed is:

1. A modular truck body, comprising:
a floor assembly;
a first storage assembly removably connected to the floor assembly;
a second storage assembly removably connected to the floor assembly; and
a bulkhead removably connected to the first and second storage assemblies.

2. The modular truck body of claim 1, wherein the floor assembly comprises:
a deck member; and
a cross member assembly connected to the deck member, wherein the cross member assembly defines at least one of the following:
a first opening, wherein the first opening is aligned with a second opening defined by the first storage assembly; and
a third opening, wherein the third opening is aligned a fourth opening defined by the second storage assembly.

3. The modular truck body of claim 2, wherein the deck member defines at least one of the following:
a fifth opening aligned with a sixth opening defined by the first storage assembly; and
a seventh opening aligned with an eighth opening defined by the second storage assembly.

4. The modular body of claim 2, wherein the cross member assembly comprises:
a channel; and
at least one of the following:
a first mounting member positioned in the channel proximate a first end of the channel, wherein the first mounting member defines the first opening; and
a second mounting member positioned in the channel proximate a second end of the channel, wherein the second mounting member defines the third opening.

5. The modular truck body of claim 4, wherein the floor assembly further comprises a second cross member assembly connected to the deck member, wherein the second cross member assembly comprises:
a second channel: and
at least one of the following:
a third mounting member positioned in the second channel proximate a first end of the second channel, wherein the third mounting member defines a fifth opening aligned with a sixth opening defined by the first storage assembly; and
a fourth mounting bracket positioned in the second channel proximate a second end of the second channel, wherein the fourth mounting member defines a seventh opening aligned with an eighth opening defined by the second storage assembly.

6. The modular truck body of claim 2, wherein the cross member assembly comprises a channel connected to the deck member, wherein the channel extends beyond first and second sides of the deck member; and wherein the channel defines at least one of the following:
the first opening; and
the third opening.

7. The modular truck body of claim 6, wherein the floor assembly further comprises a second cross member assembly connected to the deck member, wherein the second cross member assembly comprises:
a second channel, wherein the second channel extends beyond the first and second sides of the deck member, and wherein the second channel defines at least one of the following:
a fifth opening aligned with a sixth opening defined by the first storage assembly; and
a seventh opening aligned with an eighth opening defined by the second storage assembly.

8. The modular truck body of claim 1, wherein at least one of the following defines a first opening which is aligned with a second opening defined by the bulkhead:
the first storage assembly; and
the second storage assembly.

9. The modular truck body of claim 1, wherein at least one of the following defines a first opening which is aligned with a second opening defined by the tailgate assembly of the modular truck body:
the first storage assembly; and
the second storage assembly.

10. The modular truck body of claim 1, wherein at least one of the following defines a first opening which is aligned with a second opening defined by the floor assembly:
the first storage assembly; and
the second storage assembly.

11. The modular truck body of claim 10, wherein at least one of the following comprises a flange which defines the first opening:
the first storage assembly; and
the second storage assembly.

12. The modular truck body of claim 10, wherein at least one of the following comprises a mounting member which defines the first opening:
the first storage assembly; and
the second storage assembly.

13. The modular truck body of claim 12, wherein at least one of the following further comprises a second mounting member which defines a third opening which is aligned with a fourth opening defined by the floor assembly:
the first storage assembly; and
the second storage assembly.

14. The modular truck body of claim 10, wherein at least one of the following comprises a channel connected to a wall of the first storage assembly:
the first storage assembly; and
the second storage assembly, wherein the channel defines the first opening.

15. The modular truck body of claim 14, wherein the channel is removably connected to the floor assembly.

16. The modular truck body of claim 14, wherein at least one of the following further comprises a second channel connected to a second wall of the first storage assembly:
the first storage assembly; and
the second storage assembly, wherein the second channel defines a third opening which is aligned with a fourth opening defined by the floor assembly.

17. The modular truck body of claim 16, wherein the second channel is removably connected to the floor assembly.

18. The modular truck body of claim 1, wherein the bulkhead defines a first opening which is aligned with a second opening defined by at least one of the following:
the floor assembly;
the first storage assembly; and
the second storage assembly.

19. The modular truck body of claim 1, further comprising a tailgate assembly removably connected to at least one of the following:
the first storage assembly; and
the second storage assembly.

20. The modular truck body of claim 19, wherein the tailgate assembly comprises:
a tailgate;
a first mounting member connected to the tailgate, wherein the first mounting member is removably connected to the first storage assembly; and
a second mounting member connected to the tailgate, wherein the second mounting member is removably connected to the second storage assembly.
